(19) United States
(12) Patent Application Publication
(10) Pub. No.: US 2025/0353750 A1
(43) Pub. Date: Nov. 20, 2025

(54) PRODUCTION OF GRAPHENE OXIDE FROM GRAPHITE

(71) Applicant: Capattery Inc., Las Vegas, NV (US)

(72) Inventors: Susant Pattnaik, Bhubaneswar (IN); Aneeya Kumar Samantara, Bhogada (IN); Satyajit Ratha, Bhubaneswar (IN)

(21) Appl. No.: 18/943,053

(22) Filed: Nov. 11, 2024

(30) Foreign Application Priority Data
May 15, 2024 (IN) 202441038180

(51) Int. Cl. C01B 32/198

(52) U.S. Cl. CPC C01B 32/198

(57) ABSTRACT

The present disclosure provides a process for producing a graphene oxide product from a graphite source. The process comprises steps of treating the graphite source with sulphuric acid to obtain a graphite oxide in a first reaction mixture. The graphite oxide is converted to an initial graphene oxide in a second reaction mixture by adding potassium permanganate at room temperature. An oxidising mixture is added to the second reaction mixture to form a suspension. The process further comprises washing the suspension with water and dilute hydrochloric acid to obtain a wash liquor and a dispersion. The dispersion is freeze dried under vacuum to obtain the graphene oxide product. A graphene oxide product produced using the above process is also provided such that the graphene oxide product has an impurity content of less than 0.1%.

### CROSS REFERENCE TO RELATED APPLICATIONS

This application claims priority benefit of Indian Application No. 202441038180, filed in the Indian Patent Office on May 15, 2024. The above-referenced application is hereby incorporated herein by reference in its entirety.

### BACKGROUND

### Field of the Disclosure

Various embodiments of the disclosure relate generally to a process for producing graphene oxide. More specifically, various embodiments of the disclosure relate to the production of graphene oxide from graphite, and graphene oxide produced therefrom.

### Description of the Related Art

Graphene finds a wide range of potential applications due to its unique mechanical, thermal, electric, and optoelectronic properties. Graphene is composed of pure carbon and has a two-dimensional structure with carbon atoms positioned in a hexagonal pattern. Graphene is almost inert and is insoluble in water or polar organic solvents. Moreover, a lack of functional groups in graphene limits interaction of the graphene with other materials.

Graphene-based materials, for example, graphene oxide (GO), have generated great interest recently. GO finds potential applications, for example as selective membranes, catalytic systems, composites, and electrode materials. GO is synthesized mostly by oxidation of graphite. The oxidation of graphite results in oxidized edges and basal planes of the graphite which on delamination or exfoliation yields graphene oxide. The structure and properties of the resulting graphene oxide depend to a large extent on the method by which it is prepared.

GO was first synthesized by treatment of graphite powder with a mixture of fuming nitric acid (HNO₃) and potassium chlorate (KClO₃) using the Brodie method. In the well-known Hummers' method, the graphite powder is treated with a mixture of sodium nitrate (NaNO₃) and potassium permanganate (KMnO₄) in sulphuric acid (H₂SO₄). Hummers' method is widely adopted due to the shorter time of reaction and ease of reaction compared to the Brodie method. However, Hummer's method has certain drawbacks, such as liberation of toxic gases like nitrogen dioxide (NO₂) and dinitrogen tetroxide (N₂O₄), and presence of residual nitrates in the GO that is formed. Various modifications have been proposed to the Hummers' method to address some of the drawbacks of the Hummers' method. Most of the proposed modified Hummers' methods proceed for a longer time, resulting in higher costs and poor scalability for practical applications. Thus, to meet the ever-growing need for graphene oxide, a scalable, cost-effective manufacturing process is required.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments of the present disclosure, a process for producing a graphene oxide product from a graphite source is provided. The process comprises steps of treating the graphite source with sulphuric acid at a temperature in a range of −10° C. to 10° C. to obtain a graphite oxide in a first reaction mixture. The process further comprises converting the graphite oxide of the first reaction mixture to an initial graphene oxide in a second reaction mixture by adding potassium permanganate at room temperature to the first reaction mixture followed by mechanical agitation for a period of time in a range of 1.5 to 2.5 hours. The process further comprises providing an oxidising mixture to the second reaction mixture to form a suspension, wherein the oxidising mixture comprises hydrogen peroxide. The process further comprises washing the suspension with water and dilute hydrochloric acid to obtain a wash liquor and a dispersion. The process further comprises freeze drying the dispersion under vacuum to obtain the graphene oxide product.

In some embodiments, the graphene oxide product has an atomic carbon to oxygen ratio (C:O) in a range of 2:1 to 1.5:1.

In some embodiments, the graphene oxide product has an impurity content of less than 0.1%.

In some embodiments, an amount of the potassium permanganate is six to seven times greater by weight than an amount of the graphite source.

In some embodiments, the step of providing the oxidising mixture to the second reaction mixture comprises diluting the second reaction mixture with water followed by adding the hydrogen peroxide, wherein the hydrogen peroxide is added until an effervescence upon addition of the hydrogen peroxide disappears.

In some embodiments, the step of washing the suspension is repeated until the wash liquor is devoid of sulphate ions.

In some embodiments, a metal salt is added to the wash liquor to form insoluble metal sulphates indicating presence of sulphate ions in the wash liquor.

In some embodiments, the metal salt is a metal halide, and wherein a metal of the metal salt is selected from a group consisting of calcium, barium, strontium, silver, lead, and combinations thereof.

In some embodiments, the metal salt is barium chloride.

In some embodiments, the process operates in absence of an external heat supply.

In one embodiment, a graphene oxide product produced from a graphite source using a process is provided. The process comprises steps of treating the graphite source with sulphuric acid at a temperature in a range of −10° C. to 10° C. to obtain a graphite oxide in a first reaction mixture. The process further comprises converting the graphite oxide of the first reaction mixture to an initial graphene oxide in a second reaction mixture by adding potassium permanganate at room temperature to the first reaction mixture followed by mechanical agitation for a period of time in a range of 1.5 to 2.5 hours. The process further comprises providing an oxidising mixture to the second reaction mixture to form a suspension, wherein the oxidising mixture comprises hydrogen peroxide. The process further comprises washing the suspension with water and dilute hydrochloric acid to obtain a wash liquor and a dispersion. The process further comprises freeze drying the dispersion under vacuum to obtain the graphene oxide product, wherein the graphene oxide product has an impurity content of less than 0.1%.

In some embodiments, the graphene oxide product has an atomic carbon to oxygen ratio (C:O) in a range of 2:1 and 1.5:1.

In some embodiments, more than 80% of oxygen atoms of the graphene oxide product are covalently bound to carbon atoms of the graphene oxide product.

In some embodiments, the graphene oxide product has an average thickness ranging from 1 nanometre (nm) to 2 nm.

### BRIEF DESCRIPTION OF DRAWINGS

FIG. 1 is a flow chart that illustrates a process for producing a graphene oxide product from a graphite source, in accordance with an exemplary embodiment of the disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION OF EMBODIMENTS

The following description illustrates some exemplary embodiments of the disclosed disclosure in detail. Those of skill in the art will recognize that there are numerous variations and modifications of this disclosure that are encompassed by its scope. Accordingly, the description of a certain exemplary embodiment should not be deemed to limit the scope of the present disclosure.

The term “comprising” as used herein is synonymous with “including,” or “containing,” and is inclusive or open-ended and does not exclude additional, unrecited elements, or process steps.

All numbers expressing quantities of ingredients, property measurements, and so forth used in the specification are to be understood as being modified in all instances by the term “about.” Accordingly, unless indicated to the contrary, the numerical parameters set forth herein are approximations that may vary depending upon the desired properties sought to be obtained.

These and other features and advantages of the present disclosure may be appreciated from a review of the following detailed description of the present disclosure, along with the accompanying FIGURES in which like reference numerals refer to like parts throughout.

Graphite is a pure form of carbon composed of stacked layers of carbon atoms with a hexagonal crystal structure. Graphene can be described as a single-layer or multi-layered form of commonly found mineral graphite. Graphene oxide (GO) is a graphene-based material having a layered structure with oxygenated functionalities such as carbonyl group (═O), hydroxyl group (—OH), epoxy group (—O—), and carboxyl group (—COOH) attached to basal planes and along edge planes.

Graphite is known for its low resistance to shear forces due to its layered structure and this property is utilized for the preparation of graphene or graphene-based materials. Graphene oxide (GO) is synthesized mostly by oxidation of graphite. It is well-known that the structure and properties of graphene oxide depend to a large extent on the method by which it is synthesized. For example, graphene oxides, prepared by the Brodie and Hummers' methods, possess very different properties. The properties of the graphene oxides are strongly dependent on the synthesizing method, which influences the resulting number and type of oxygen-containing groups or oxygen functionalities in the formed GO. Due to the presence of various oxygen functionalities on GO, GO can be used as a starting material for the synthesis of other graphene-based materials, such as fluorographene, bromographene, and many others. Further, by thermal or chemical reduction of GO, thermally or chemically reduced graphene can be prepared.

According to embodiments of the present disclosure, a process for producing a graphene oxide product from a graphite source is provided. The process comprises steps of treating the graphite source with sulphuric acid at a temperature in a range of −10° C. to 10° C. to obtain a graphite oxide in a first reaction mixture. The process further comprises converting the graphite oxide to an initial graphene oxide in a second reaction mixture by adding potassium permanganate at room temperature to the first reaction mixture followed by mechanical agitation for a period of time in a range of 1.5 to 2.5 hours. The process further comprises providing an oxidising mixture to the second reaction mixture to form a suspension, wherein the oxidising mixture comprises hydrogen peroxide. The process further comprises washing the suspension with water and dilute hydrochloric acid to obtain a wash liquor and a dispersion. The process further comprises freeze drying the dispersion under vacuum to obtain the graphene oxide product.

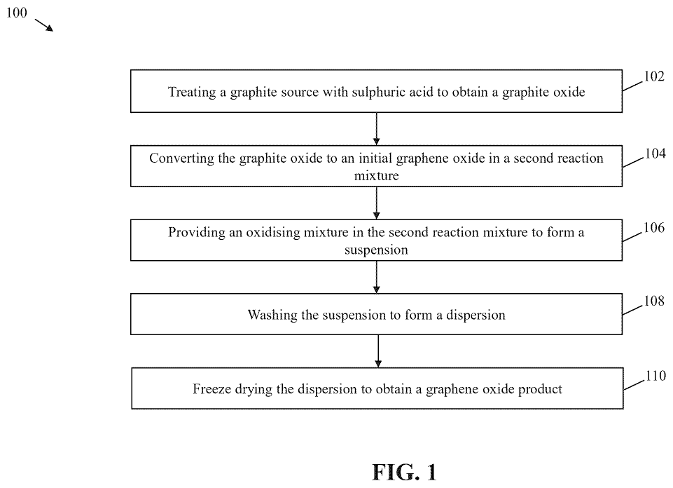

FIG. 1 is a flow chart 100 that illustrates a process for producing a graphene oxide product from a graphite source through exemplary steps 102 through 110, according to embodiments of the present disclosure. At step 102, a graphite source is treated with sulphuric acid to obtain a graphite oxide in a first reaction mixture.

The graphite source comprises graphite and can be of natural origin or synthetic origin. The graphite source has a purity of greater than 98%. In one embodiment, the purity of the graphite source is greater than 99%. Graphite of the graphite source can be in the form of flakes, or powder. In one embodiment, the graphite source has a particle size of less than 50 microns (μm). In another embodiment, the particle size of the graphite source is in a range of 25 μm to 50 μm.

At step 102, the graphite source is treated with sulphuric acid to obtain the graphite oxide in the first reaction mixture. In one embodiment, the sulphuric acid is anhydrous having a concentration of 97%. In another embodiment, the sulphuric acid has a concentration of greater than 97%. A ratio of weight percent of the graphite source to the sulphuric acid in the first reaction mixture is in a range of 1:2 to 1:5.

The term “graphite oxide”, as used herein, refers to products obtained at step 102, and includes graphite having various oxygenated functionalities with varying degrees of oxidation. Examples of oxygenated functionalities include carbonyl group, hydroxyl group, carboxyl group, epoxy group, and combinations thereof. The oxygenated functionalities are mostly formed over exposed surfaces of the graphite such as edges and basal planes of the graphite. The graphite oxide may also include sulphated reaction products of graphite with sulphuric acid.

The graphite source is treated with sulphuric acid at a temperature in a range of −10° C. to 10° C. to obtain the graphite oxide in the first reaction mixture. In one embodiment, the graphite source is placed over a cold bath and anhydrous sulphuric acid is poured into it. Similarly, the graphite source may be added to the anhydrous sulphuric acid placed over the cold bath. The cold bath is maintained at a temperature in a range of −10° C. to 10° C. In one embodiment, the cold bath is an ice bath. The treatment proceeds through mechanical agitation over a period of time in a range of 20 minutes to 40 minutes. Mechanical agitation can be accomplished by using a magnetic stirrer in one instance.

At step 104, the graphite oxide of the first reaction mixture is converted to an initial graphene oxide in a second reaction mixture. The graphite oxide is treated with anhydrous potassium permanganate at room temperature. As used herein, the term “room temperature” refers to a temperature in a range of 25 to 35° C. In one embodiment, the room temperature is achieved by placing the first reaction mixture over a water bath.

The first reaction mixture is placed over a water bath and anhydrous potassium permanganate is added to the first reaction mixture at room temperature followed by mechanical agitation for a period of time in a range of 1.5 to 2.5 hours. In one embodiment, potassium permanganate is taken in an amount that is 6 to 7 times greater than an amount of the graphite source taken in step 102. The amount of potassium permanganate, in one embodiment, is expressed in terms of weight percent. The potassium permanganate may be added in the form of flakes.

The mechanical agitation helps in exfoliating graphite oxide by reducing the weak van der Waal's forces of attraction holding graphite oxide layers together. In one embodiment, mechanical agitation is achieved by ultrasonicating the first mixture. Other techniques such as centrifugation, magnetic stirring may be utilized to form the second mixture.

The graphite oxide undergoes oxidative exfoliation, at step 104, to form the initial graphene oxide. The initial graphene oxide formed is characterized by oxygen atoms that are covalently bound to carbon atoms of the graphene, especially on basal planes between layers of graphene. The term “initial graphene oxide”, as used herein, refers to products obtained at step 104, and includes graphene having various oxygenated functionalities with varying degrees of oxidation. Examples of oxygenated functionalities include carbonyl group, hydroxyl group, carboxyl group, epoxy group, and combinations thereof. The oxygenated functionalities may be found attached to basal planes and along the edges of the graphene structure. The initial graphene oxide may also include sulphated reaction products formed at step 102 and derivatives formed therefrom. The initial graphene oxide may also include undesirable oxidative species and impurities. The term “undesirable oxidative species” refers to oxidation products where oxygen is not covalently bound to carbon atoms of the graphene oxide.

At step 106, an oxidizing mixture is provided in the second reaction mixture to form a suspension. The oxidizing mixture comprises hydrogen peroxide. In one embodiment, the step of providing the oxidising mixture to the second reaction mixture comprises diluting the second reaction mixture with water followed by adding hydrogen peroxide. The hydrogen peroxide oxidises the undesirable oxidative species and any unreacted permanganate and manganese dioxide formed at step 104 to a species that is easily removable at subsequent process steps. The hydrogen peroxide also converts sulphated reaction products obtained at step 102 to sulphate ions which may be removable at a subsequent step.

The addition of hydrogen peroxide proceeds through evolution of gas bubbles or effervescence. An amount of hydrogen peroxide that is to be added is decided based on the ensuing effervescence and the addition of hydrogen peroxide is stopped when the effervescence disappears.

At step 108, the suspension is washed with water and dilute hydrochloric acid to form a wash liquor and a dispersion. The suspension is continuously washed with water and dilute hydrochloric acid until the suspension is devoid of sulphate ions.

In one embodiment, a metal salt is added to the wash liquor to form insoluble metal sulphates indicating presence of sulphate ions in the wash liquor. The suspension is washed until all the sulphate ions precipitate as the metal sulphate on addition of the metal salt to the wash liquor. In one embodiment, the metal salt is a metal halide comprising metal chloride, metal bromide, metal iodide, or combinations thereof. A metal of the metal salt is selected from a group consisting of calcium, barium, strontium, silver, lead, and combinations thereof. In one embodiment, the metal salt is barium chloride. The hydrochloric acid provides an acidic environment for the metal sulphate to precipitate.

At step 110, the dispersion is freeze dried to obtain the graphene oxide product, wherein the graphene oxide product has an impurity content of less than 0.1%. On freeze drying, sublimation of water takes place leaving the graphene oxide product in dry form. The step 110, of freeze drying preserves layered structure of the graphene oxide product and prevents any agglomeration of individual graphene oxide molecules.

In one embodiment, the graphene oxide product has an atomic carbon to oxygen ratio (C:O) in a range of 2:1 and 1.5:1.

In yet another embodiment, graphene oxide product has an average thickness ranging from 1 nanometre (nm) to 2 nm. The average thickness of the graphene oxide product corresponds to 3 to 5 atomic layers.

In yet another embodiment, more than 80% of oxygen atoms of the graphene oxide product are covalently bound to carbon atoms of the graphene oxide product.

A particular advantage of the present disclosure is the process can be operated in absence of an external heat supply. The process steps are performed at room temperature or below room temperature which translates to considerable energy savings.

The process is performed using milder chemicals and as a result, the side products formed are non-toxic, while prior art methods utilizing nitrates produce toxic gases.

The graphene oxide product is extracted through freeze drying from water-based dispersion, thus avoiding the use of organic solvents. The graphene oxide product obtained according to embodiments of the present disclosure has minimal impurity content of less than 0.1%.

The process described in conjunction with FIG. 1, can be performed as a continuous process, semi-continuous process, or as a batch process. The graphene oxide product produced according to embodiments of the present disclosure has a lateral dimension ranging from 1 to 5 microns. In another embodiment, the graphene oxide product has a lateral dimension ranging from 1 to 3 microns.

The overall yield of the graphene oxide product produced according to embodiments of the present disclosure is more than 90%. In one embodiment, the overall yield of the graphene oxide product produced from the process is more than 99%. The steps 102 to 110, and the processing parameters such as time period, and temperature have been instrumental in achieving the obtained yield and purity of the graphene oxide product.

the Below Example has been Provided for the Preparation of Graphene Oxide:

About 25 milliliters (ml) of anhydrous sulphuric acid was poured into 5 grams (g) of graphite flakes kept in an ice bath with constant stirring for about 30 minutes to form a first mixture. The first mixture was taken out from the ice bath and about 32 grams of potassium permanganate was added slowly 202441038180 with vigorous stirring. The first mixture was then placed over a water bath at room temperature followed by mechanical agitation for 2 hours to form a second mixture. About 50 ml of deionized water was added to the second mixture in batches. An aqueous hydrogen peroxide solution (50%) was added to the second mixture with ensuing effervescence. The addition of hydrogen peroxide was stopped with the disappearance of effervescence to form a suspension. The suspension was washed with a mixture of water and dilute hydrochloric acid to obtain a wash liquor. The wash liquor was tested for the presence of sulphate ions by adding barium chloride which formed a white precipitate. The washing was continued till there was no more observable precipitation resulting in a sulphate ion-free dispersion. The dispersion was freeze dried under vacuum to obtain graphene oxide in powder form. The graphene oxide was characterized using various techniques.

A Raman spectrum of the graphene oxide gave an ID/IG value of 1.78, indicating the presence of defects, when compared to graphite, on both the basal and edge planes of graphene oxide due to the presence of oxygen functionalities. Here Ip corresponds to the intensity of Raman band at 1350 cm⁻¹ and IG corresponds to the intensity of Raman band at 1580 cm⁻¹.

An X-ray photoelectron spectroscopic (XPS) analysis of graphene oxide revealed two peaks, one approximately at 284 electron Volts (eV) corresponding to the binding energy of carbon, and the other peak approximately at 530 eV corresponding to the binding energy of oxygen. The XPS confirmed the presence of both carbon and oxygen in the graphene oxide. The stochiometric ratio of carbon to oxygen (C:O) was found to be 1:1.3.

A Fourier-transform Infrared (FTIR) spectrum confirmed the presence of different oxygen functionalities. A broad peak at 3429 cm⁻¹ was attributed to the stretching mode of O—H bond thus confirming the presence of hydroxyl groups in graphene oxide. The band observed at 1720 cm⁻¹ was assigned to the C═O stretch. The peaks at 1225 cm⁻¹ and 1056 cm⁻¹ were assigned to C—O—C stretching and C—O group confirming the presence of carboxyl group. The peak at 1627 cm⁻¹ corresponded to the C═C stretching of the carbon atoms of the graphene oxide.

An Energy dispersive spectrometric (EDS) study conducted on the graphene oxide substantiated the presence of carbon and oxygen atoms thus confirming the elemental composition of the graphene oxide.

An Atomic force microscopic (AFM) study was conducted on the graphene oxide. AFM image revealed an average thickness of the graphene oxide to be approximately 1.2 nm which corresponds to 3 to 4 layers of graphene of the graphene oxide.

It is to be understood that the above description is intended to be illustrative, and not restrictive. Furthermore, many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the scope of the appended claims.

What is claimed is:

1. A process for producing a graphene oxide product from a graphite source comprising steps of:
treating the graphite source with sulphuric acid at a temperature in a range of −10° C. to 10° C. to obtain a graphite oxide in a first reaction mixture;
converting the graphite oxide of the first reaction mixture to an initial graphene oxide in a second reaction mixture by adding potassium permanganate at room temperature to the first reaction mixture followed by mechanical agitation for a period of time in a range of 1.5 to 2.5 hours;
providing an oxidising mixture to the second reaction mixture to form a suspension, wherein the oxidising mixture comprises hydrogen peroxide;
washing the suspension with water and dilute hydrochloric acid to obtain a wash liquor and a dispersion; and
freeze drying the dispersion under vacuum to obtain the graphene oxide product.

2. The process as claimed in claim 1, wherein the graphene oxide product has an atomic carbon to oxygen ratio (C:O) in a range of 2:1 to 1.5:1.

3. The process as claimed in claim 1, wherein the graphene oxide product has an impurity content of less than 0.1%.

4. The process as claimed in claim 1, wherein an amount of the potassium permanganate is six to seven times greater by weight than an amount of the graphite source.

5. The process as claimed in claim 1, wherein the step of providing the oxidising mixture to the second reaction mixture comprises diluting the second reaction mixture with water followed by adding the hydrogen peroxide, and wherein the hydrogen peroxide is added until an effervescence upon addition of the hydrogen peroxide disappears.

6. The process as claimed in claim 1, wherein the step of washing the suspension is repeated until the wash liquor is devoid of sulphate ions.

7. The process as claimed in claim 1, wherein a metal salt is added to the wash liquor to form insoluble metal sulphates indicating presence of sulphate ions in the wash liquor.

8. The process as claimed in claim 7, wherein the metal salt is a metal halide, and wherein a metal of the metal salt is selected from a group consisting of calcium, barium, strontium, silver, lead, and combinations thereof.

9. The process as claimed in claim 8, wherein the metal salt is barium chloride.

10. The process as claimed in claim 1, wherein the process operates in absence of an external heat supply.

11. A graphene oxide product produced from a graphite source using a process comprising steps of:
treating the graphite source with sulphuric acid at a temperature in a range of −10° C. to 10° C. to obtain a graphite oxide in a first reaction mixture;
converting the graphite oxide of the first reaction mixture to an initial graphene oxide in a second reaction mixture by adding potassium permanganate at room temperature to the first reaction mixture followed by mechanical agitation for a period of time in a range of 1.5 to 2.5 hours;
providing an oxidising mixture to the second reaction mixture to form a suspension, wherein the oxidising mixture comprises hydrogen peroxide;
washing the suspension with water and dilute hydrochloric acid to obtain a wash liquor and a dispersion; and
freeze drying the dispersion under vacuum to obtain the graphene oxide product, wherein the graphene oxide product has an impurity content of less than 0.1%.

12. The graphene oxide product as claimed in claim 11, wherein the graphene oxide product has an atomic carbon to oxygen ratio (C:O) in a range of 2:1 to 1.5:1.

13. The graphene oxide product as claimed in claim 11, wherein more than 80% of oxygen atoms of the graphene oxide product are covalently bound to carbon atoms of the graphene oxide product.

14. The graphene oxide product as claimed in claim 11, wherein the graphene oxide product has an average thickness ranging from 1 nanometre (nm) to 2 nm.
